(19) United States
(12) Patent Application Publication
(10) Pub. No.: US 2019/0136814 A1
(43) Pub. Date: May 9, 2019

(54) GAS VEHICLE INJECTOR HAVING IMPROVED LUBRICATION CHARACTERISTICS

(71) Applicant: DONGBANGTECH CO., LTD, Busan (KR)

(72) Inventors: Dong-Jo KIM, Busan (KR); Jong-Wan LIM, Gyeongsangnam-Do (KR)

(21) Appl. No.: 15/805,936

(22) Filed: Nov. 7, 2017

(51) Int. Cl. F02M 61/16; F02M 51/06

(52) U.S. Cl. CPC F02M 61/16; F02M 55/02; F02M 51/061

(57) ABSTRACT

Disclosed is a gas vehicle injector having improved lubrication characteristics. The injector is provided with a housing installed at a fuel supply pipe of an engine, a needle valve installed at a lower portion of the housing and having an injection nozzle, a coil installed inside the housing and generating a magnetomotive force by receiving electric power, a solenoid having a core generating an attractive force by the magnetomotive force, and a plunger reciprocating and installed below the solenoid, and the injector includes: a depression groove circumferentially formed on an inner circumferential surface of the housing; and a communication groove formed on the inner circumferential surface of the housing, and communicating with the depression groove.

### BACKGROUND OF THE INVENTION

### Field of the Invention

The present invention relates generally to a gas vehicle injector having improved lubrication characteristics. More particularly, the present invention relates to a gas vehicle injector having improved lubrication characteristics in which lubrication characteristics are improved between a housing and a plunger of the injector for a vehicle using gaseous fuel.

### Description of the Related Art

Recently, a vehicle using gas such as liquefied petroleum gas (LPG), liquefied natural gas (LNG), natural compressed gas (CNG), etc. as fuel has been widely used in consideration of economical efficiency and environmental friendliness. Compressed natural gas (CNG) is less expensive than gasoline, and is in a gaseous state so that fuel distribution to each cylinder is uniform. In addition, exhaust gas is less polluted compared to gasoline, which is advantageous in terms of environment.

Further, when compressed natural gas is used as a vehicle fuel, minimal knocking occurs because the octane rating thereof is high. In addition, loss of lubricating oil is small, and engine warm-up is fast. As such, compressed natural gas, which has relatively many advantages over gasoline, is widely used as fuel for a commercial vehicle including a taxi and a bus.

This gas vehicle is configured to atomize and inject the gaseous fuel into the cylinder of the engine, and an injector is used for this purpose. The injector is usually controlled by an electronic control unit (ECU) mounted in the vehicle. The electronic control unit (ECU) controls the injection timing of the injector based on the position of the accelerator pedal under various external conditions.

FIG. 1 is a schematic view schematically showing a sectional configuration of a conventional injector. As shown in FIG. 1, the conventional injector includes a solenoid coil 13 and a plunger 14 such that the plunger 14 is lifted by a magnetic force generated when electric power is applied to the solenoid coil 13 by the ECU. Then, the injector is separated from a nipple 16 whereby the fuel introduced into the inlet is injected through an injection hole 17.

Meanwhile, the conventional injector as described above is problematic in that the outer surface of the plunger is abraded by friction with the peripheral members (the inner surface of the housing, the core, the needle) during a reciprocating motion of the plunger due to the magnetic force generated in the solenoid coil, so the operation performance is significantly reduced. In addition, particles formed by abrasion remain inside the injector, thereby shortening the replacement cycle of parts due to malfunction.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention provides a gas vehicle injector having improved lubrication characteristics, wherein a lubricating oil line is provided between a plunger and a housing whereby frictional force generated due to a reciprocating motion of the plunger is reduced, and abraded particles formed due to friction are discharged to the outside of the injector together with the lubricating oil accommodated in the lubricating oil line. In addition, the replacement cycle of parts is extended.

In order to achieve the above object, according to one aspect of the present invention, there is provided a gas vehicle injector having improved lubrication characteristics, the injector being provided with a housing installed at a fuel supply pipe of an engine, a needle valve installed at a lower portion of the housing and having an injection nozzle, a coil installed inside the housing and generating a magnetomotive force by receiving electric power, a solenoid having a core generating an attractive force by the magnetomotive force, and a plunger reciprocating and installed below the solenoid, the injector including: a depression groove circumferentially formed on an inner circumferential surface of the housing; and a communication groove formed on the inner circumferential surface of the housing, and communicating with the depression groove.

According to the gas vehicle injector having improved lubrication characteristics, the depression groove is circumferentially formed on the inner circumferential surface of the housing and the communication groove is formed on the inner circumferential surface of the housing to communicate with the depression groove. Thus, when the plunger reciprocates in the housing, the lubricating oil or gaseous fuel remaining in both the depression groove and the communication groove can form an oil film between the plunger and the housing, and thus the lubrication characteristics can be improved.

In addition, since the communication groove is inclinedly formed on the inner circumferential surface of the housing, a contact radius with the outer surface of the plunger is increased, and thus an oil film can be formed evenly on the outer surface of the plunger.

Moreover, since the communication groove is formed to extend downward from the depression groove, the abraded particles formed due to frequent friction between the plunger and the peripheral members can be discharged to the outside of the injector together with the lubricating oil or gaseous fuel accommodated in the communication groove.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view schematically showing sectional configuration of a conventional injector;

FIG. 2 is a cross-sectional view showing a gas vehicle injector having improved lubrication characteristics according to an embodiment of the present invention;

FIG. 3 is a schematic view showing an inner circumferential surface of a housing according to an embodiment of the present invention; and

FIG. 4 is a schematic view showing the inner circumferential surface of the housing according to another embodiment of the present invention.

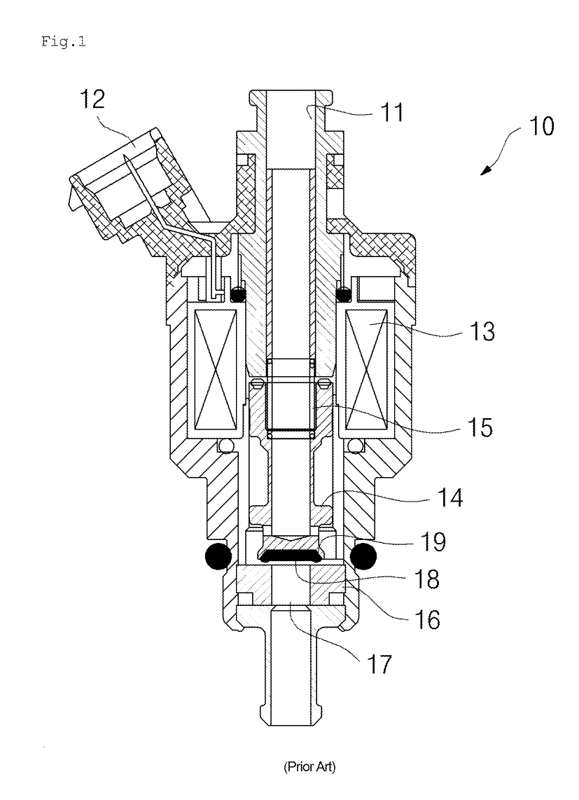

### DETAILED DESCRIPTION OF THE INVENTION

However, the drawings are provided as example for those skilled in the art to be able to more clearly understand the spirit of the present invention. Accordingly, the present invention is not limited to the drawings and may be achieved in other ways.

In the following description, it is to be noted that, when the functions of conventional elements and the detailed description of elements related with the present invention may make the gist of the present invention unclear, a detailed description of those elements will be omitted.

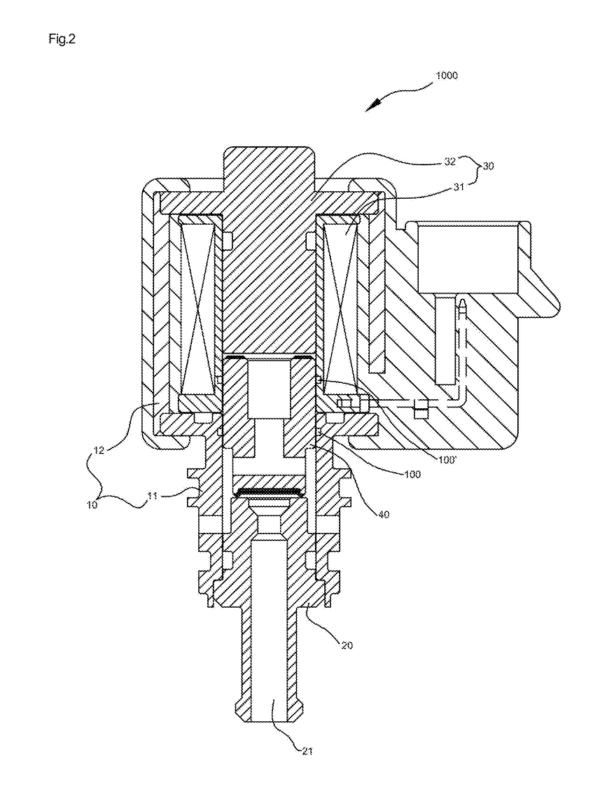

FIG. 2 is a cross-sectional view showing a gas vehicle injector having improved lubrication characteristics according to an embodiment of the present invention.

A gas vehicle injector 1000 having improved lubrication characteristics according to the present invention is provided with a housing 10 installed at a fuel supply pipe of an engine, a needle valve 20 installed at a lower portion of the housing 10 and having an injection nozzle 21, a coil 31 installed inside the housing 10 and generating a magnetomotive force by receiving electric power, a solenoid 30 having a core 32 generating an attractive force by the magnetomotive force, and a plunger 40 reciprocating and installed below the solenoid 30, and the injector includes: a depression groove 100 circumferentially formed on an inner circumferential surface of the housing 10; and a communication groove (not shown) formed on the inner circumferential surface of the housing 10 and communicating with the depression groove 100.

Both the depression groove 100 and the communication groove are spaces for accommodating lubricating oil or gaseous fuel. The lubricating oil or gaseous fuel accommodated in the depression groove 100 and the communication groove 200 comes in contact with an outer surface of the plunger 40 during a reciprocation motion of the plunger 40, and forms an oil film on the outer surface of the plunger 40.

Further, the communication groove is inclinedly formed with respect to the depression groove 100, so that the lubricating oil can efficiently flow in the communication groove and the depression groove 100.

In addition, the communication groove extends downward from the depression groove 100 so that a contact area with the outer surface of the plunger 40 can be increased, and the oil film can be efficiently formed on the outer surface of the plunger 40. Moreover, the abraded particles formed due to frequent friction of the reciprocating plunger 40 can be discharged to the outside of the injector together with the lubricating oil or gaseous fuel accommodated in the communication groove.

Further, the housing 10 has a dual structure in which an lower housing 11 and a upper housing 12 are coupled to each other. The dual-structured housing 10 facilitates easy inspection and replacement of the solenoid 30 and the plunger 40.

The needle valve 20, the solenoid 30, and the plunger 40 remain the same as those of the conventional injector for a gas vehicle, so that detailed descriptions of their structure and operation principle will be omitted.

Further, the depression groove 100 is circumferentially formed on the inner circumferential surface of the housing 10, and a plurality of depression grooves 100′ are formed to be distanced from the depression groove 100 at a predetermined interval whereby lubrication performance can be improved.

In addition, the depression groove 100 is formed at an upper portion of an inner circumferential surface of the lower housing 11 to be vertically distanced from a lower portion of an outer surface of the plunger 40. The depression groove 100′ is formed at a lower portion of an inner circumferential surface of the upper housing 12 to be vertically distanced from an upper portion of the outer surface of the plunger 40.

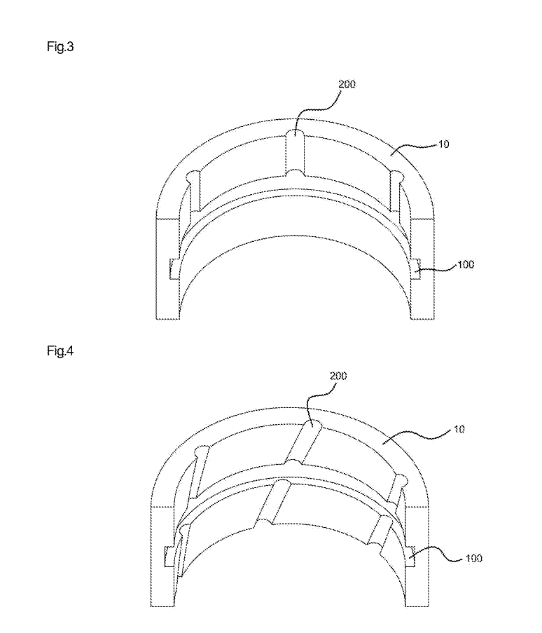

FIG. 3 is a schematic view showing the inner circumferential surface of the housing according to an embodiment of the present invention.

As shown FIG. 3, the depression groove 100 and the communication groove 200, which are the most important features of the present invention, are formed on the inner circumferential surface of the housing 10.

The depression groove 100 is circumferentially formed on the inner circumferential surface of the housing 10 and has a rectangular shape in cross section as shown in FIG. 3. However, the depression groove may have a semicircular shape, a triangular shape etc. in cross section such that the lubricating oil is accommodated therein.

Next, the communication groove 200 is formed on the inner circumferential surface of the housing 10 to communicate with the depression groove 100, and is inclinedly formed at a predetermined inclination angle with respect to the depression groove 100 in the lengthwise direction of the housing 10.

In addition, the communication groove 200 communicates with the depression groove 100 and extends to an upper surface of the lower housing 11. A plurality of communication grooves 200 are formed to be distanced from each other at a predetermined interval on the inner circumferential surface of the housing 10, whereby an oil film can be formed on the entire outer surface of the plunger 40.

FIG. 4 is a schematic view showing the inner circumferential surface of the housing according to another embodiment of the present invention.

As shown in FIG. 4, the communication groove 200 is inclinedly formed at a predetermined inclination angle with respect to the depression groove 100. As the communication groove 200 is inclinedly formed with respect to the depression groove 100, a contact radius with the outer surface of the plunger 40 is increased, whereby the lubricating oil or gas fuel flowing in the communication groove 200 can form an oil film on the entire outer surface of the reciprocating plunger 40.

In addition, the communication groove 200 extends downward from the depression groove 100 and may extend to a lower portion of the plunger 40. Even though the lubrication performance is improved on the inner surface of the housing 10 and on the outer surface of the plunger 40, abraded particles are generated by the continuous friction. At this time, the communication groove 200 allows the abraded particles to flow down and to be discharged.

According to the gas vehicle injector 1000 having improved lubrication characteristics according to the present invention, the depression groove 100 and the communication groove 200 are formed on the inner circumferential surface of the housing 10. Thus, even when the gas vehicle injector 1000 having improved lubrication characteristics is installed parallel to the ground rather than being installed vertically at the fuel supply pipe of the engine of the gas vehicle, the lubricating oil or gaseous fuel can remain in the housing 10, whereby an oil film can be efficiently formed on the plunger 40.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A gas vehicle injector having improved lubrication characteristics, the gas vehicle injector including a housing installed at a fuel supply pipe of an engine, a needle valve installed at a lower portion of the housing and having an injection nozzle, a coil installed inside the housing and generating a magnetomotive force by receiving electric power, a solenoid having a core generating an attractive force by the magnetomotive force, and a plunger reciprocating and installed below the solenoid, the gas vehicle injector comprising:
a depression groove circumferentially formed on an inner circumferential surface of the housing; and
a communication groove formed on the inner circumferential surface of the housing, and communicating with the depression groove.

2. The gas vehicle injector of claim 1, wherein the communication groove is inclinedly formed at a predetermined inclination angle with respect to the depression groove.

3. The gas vehicle injector of claim 1, wherein the communication groove extends downward from the depression groove.
